(19) United States
(12) Patent Application Publication
(10) Pub. No.: US 2022/0243510 A1
(43) Pub. Date: Aug. 4, 2022

(54) VEHICLE HINGE AND METHOD FOR PRODUCING A HINGE HALF FOR A VEHICLE HINGE

(71) Applicant: Edscha Engineering GmbH, Remscheid (DE)

(72) Inventor: Stefan PRISON, Remscheid (DE)

(21) Appl. No.: 17/613,484

(22) PCT Filed: Jun. 5, 2020
(86) PCT No.: PCT/DE2020/100476

§ 371 Date: Nov. 22, 2021

(30) Foreign Application Priority Data
Jun. 7, 2019 (DE) 10 2019 115 563.0

(51) Int. Cl. E05D 5/12; E05D 5/02

(52) U.S. Cl. CPC E05D 5/121; E05D 5/128; E05D 2005/102; E05Y 2201/632; E05D 5/0207

(57) ABSTRACT

A vehicle hinge, in particular for use for pivotable vehicle hinged closure elements, includes a first hinge half (2) having at least one first hinge half part (3); a second hinge half (10); and a hinge pin (18), which connects the first hinge half (2) and the second hinge half (10) in an articulated manner. The hinge pin (18) is mounted in an articulated manner in one of the first hinge half (2) and the second hinge half (10) and can be fastened in a rotational fixed manner to the other of the first hinge half (2) and the second hinge half (10). A retaining ring (21) penetrated by a retaining portion of the hinge pin (18) is arranged between the first hinge half (2) and the second hinge half (10). The retaining ring (21) is fastened, by a central hole, on the retaining portion of the hinge pin (18) by a press fit.

The present disclosure relates to a vehicle hinge, in particular to use for pivotable vehicle flaps. The present disclosure also relates to a method for producing a hinge half of a vehicle hinge.

### BACKGROUND

Vehicle hinges being arranged between a vehicle door or vehicle flap element to be pivoted and a vehicle body are known from practice. Such vehicle hinges comprise a first hinge half being attached to the vehicle door, for example, and a second hinge half being attached to the vehicle body. The hinge halves are connected to one another via a hinge pin such that the first hinge half is pivotable in relation to the second hinge half.

DE 195 39 423 C2 discloses a vehicle hinge having a first hinge half, the first hinge half being formed by a first hinge half part. The vehicle hinge also comprises a second hinge half which is formed by a second hinge half part and is connected in an articulated manner to the first hinge half via a hinge pin. The hinge pin has a shaft, wherein the shaft penetrates hinge eyes which are provided on each of the hinge half parts. The hinge pin has a radial collar in a region between the two hinge half parts, which collar separates an articulated portion around which the first hinge half part is rotatably mounted and a locking portion on which the second hinge half part is non-rotatably secured. In the locking portion, the shaft of the hinge pin has a circumferential profile such that the hinge pin is non-rotatably arranged in the hinge eye of the second hinge half part. The hinge pin is secured axially with respect to the first hinge half part by means of a retaining ring by the retaining ring being fixed by means of riveting above an upper face of the first hinge eye. The disadvantage of the vehicle hinge shown is that the riveted retaining ring is exposed to corrosion damage due to the riveting and therefore over time does not have sufficient retaining force to secure the hinge pin in the hinge half part in the long term. In addition, if the bearing point is subjected to greater stress, for example in the event of an accident, there is a risk that the rivet head will break off above the retaining ring. There is this risk in particular in vehicles having more rigid body structures, in particular electric vehicles, since in these the bearing point of the vehicle hinges is exposed to higher loads.

DE 11 2008 002 475 B4 discloses a vehicle hinge having a first hinge half and a second hinge half, the first hinge half being connected in an articulated manner to the second hinge half by means of a hinge pin. The hinge pin has a locking portion to which one of the hinge half parts can be joined in a rotationally fixed manner and has an articulated portion around which the other hinge half part is arranged in an articulated manner.

CN 208137718 U discloses a vehicle hinge, comprising a first hinge half having a first hinge half part and a second hinge half, the first hinge half and the second hinge half being connected in an articulated manner via a hinge pin. The hinge pin is mounted in an articulated manner in the first hinge half and locked on the second hinge half in a rotationally fixed manner. A sealing ring is arranged between the first hinge half and the second hinge half, the sealing ring being penetrated by the hinge pin. The disadvantage of the vehicle hinge shown is that the sealing ring is not sufficiently secured in the axial direction and thus does not ensure that the hinge pin is axially fixed relative to the first hinge half.

### SUMMARY

An object of the present disclosure is to provide a vehicle hinge which can withstand higher loads, in particular at the bearing point, and is inexpensive and simple to produce.

According to one aspect of the present disclosure, a vehicle hinge is provided, comprising a first hinge half having at least one first hinge half part, a second hinge half, and a hinge pin connecting the first hinge half and the second hinge half in an articulated manner. The hinge pin is mounted in an articulated manner in one of the first hinge half and the second hinge half and is lockable on the other of the first hinge half and the second hinge half in a rotationally fixed manner. The vehicle hinge according to the present disclosure is characterized in that a retaining ring which is penetrated by a retaining portion of the hinge pin is arranged between the first hinge half and the second hinge half, and in that the retaining ring is fixed by means of a central hole to the retaining portion of the hinge pin by a press fit. In this way, the hinge pin can advantageously be axially secured in one of the first hinge half and the second hinge half without riveting such that the risk of subsequent corrosion, which frequently occurs in particular after riveting when the bronze mesh has been imprinted into the base material of the vehicle hinge during flanging, is reduced. The retaining ring effectively replaces the rivet head in the vehicle hinge according to the present disclosure such that the vehicle hinge, due to the potentially larger cross section of the retaining ring in comparison with the rivet head, has a greater load-bearing capacity and at the same time is cheaper and simpler to produce since the riveting process can be omitted.

The hinge pin particularly preferably has a stepped shaft. As a result, the hinge pin can be flexibly reinforced in specific portions while having smaller diameters in other portions such that material can be economized and at the same time the breaking strength of the hinge pin is maintained. A conventional stepped rivet pin can advantageously be used as the hinge pin. The hinge pin preferably has an articulated portion around which the one at the first hinge half and the second hinge half is arranged in an articulated manner.

The hinge pin also expediently has a locking portion on which the hinge pin is lockable on the other of the first hinge half and the second hinge half in a rotationally fixed manner. The hinge pin can preferably be locked on the other of the first hinge half and the second hinge half by means of a locking means in a rotationally fixed manner. The locking means is particularly preferably designed as a set screw. This advantageously ensures that the hinge pin can be rotated together with the other of the first hinge half and the second hinge half with respect to the one of the first hinge half and the second hinge half, thus allowing a defined pivoting of the vehicle flap.

In a preferred embodiment, the one of the first hinge half and the second hinge half together with the retaining ring can be lifted out of the other of the first hinge half and the second hinge half. Advantageously, the first hinge half can be transported together with the hinge pin and easily connected to the second hinge half during assembly, the hinge pin being axially locked in the first hinge half by the retaining ring and secured from creeping out of the one of the first hinge half and the second hinge half.

The first hinge half preferably comprises a first hinge eye which is penetrated by the hinge pin. The hinge eye advantageously defines a bearing axis through a first eye bore, about which axis the first hinge half can be rotated relative to the second hinge half. The second hinge half expediently comprises a second hinge eye having a second eye bore. The second hinge eye is penetrated by the hinge pin. In a first embodiment, the first hinge eye has a first eye bore having a diameter which differs from a diameter of a second eye bore of the second hinge eye. Alternatively, the eye bores of the first hinge eye and of the second hinge eye have the same diameter.

The vehicle hinge particularly preferably comprises a hollow cylindrical bearing bush, wherein the bearing bush penetrates the hinge eye of the one of the first hinge half and the second hinge half. Advantageously, the one of the first hinge half and the second hinge half can be mounted in an articulated manner around the hinge pin, wherein the bearing bush prevents direct contact between the hinge pin and the hinge eye or eye bore and thus provides improved and lower friction bearing.

The bearing bush expediently has at least one first collar, the first collar being arranged between the retaining ring and the one of the first hinge half and the second hinge half. This advantageously ensures that the retaining ring provides axial securing of the hinge pin but does not hinder the articulated rotation of the first hinge half about the hinge pin.

In a preferred embodiment, the bearing bush has a second collar, wherein the second collar is arranged between an upper face of the first hinge eye and an end-face head of the hinge pin. Direct contact between the hinge pin and the hinge eye is advantageously prevented such that articulated bearing of the first hinge half with respect to the hinge pin is ensured.

According to a further aspect of the present disclosure, a method is provided for producing a hinge half of a vehicle hinge, comprising a hinge half part having a hinge eye, a hinge pin having an end-face head and a shaft, and a retaining ring. The method according to the present disclosure comprises the steps of inserting the shaft of the hinge pin into the hinge eye such that the head of the hinge pin is arranged above an upper face of the hinge eye. The method also comprises the step of pressing a retaining ring onto a retaining portion of the hinge pin that protrudes from a lower face of the hinge eye du ring or after insertion of the shaft of the hinge pin into the hinge eye. This method advantageously allows a hinge half of a vehicle hinge to be produced in which a hinge pin to be connected to a second hinge half is securely mounted in the first hinge half part and it is ensured that the hinge pin does not fall out of or cannot be pressed out of the hinge half part during transport or during assembly. Furthermore, the hinge half advantageously has a structure which is more capable of withstanding higher loads since the hinge pin is not axially secured by riveting and the retaining ring has a larger cross section than a corresponding rivet head.

Further advantages, features and properties of the present disclosure will become apparent from the following description of a preferred embodiment.

### BRIEF DESCRIPTION OF THE DRAWINGS

The present disclosure will be explained in more detail below with reference to the accompanying drawings based on a preferred embodiment of the present disclosure.

FIG. 1 shows a preferred embodiment of a vehicle hinge according to the present disclosure in a side view.

FIG. 2 shows the vehicle hinge from FIG. 1 in a cut-away side view.

FIG. 3 shows the vehicle hinge from FIG. 1 or FIG. 2 in an exploded view.

### DETAILED DESCRIPTION

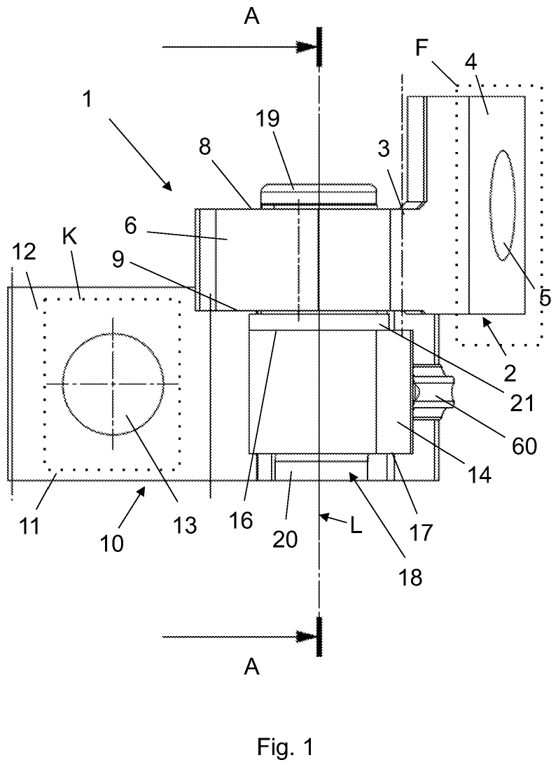

FIG. 1 shows a preferred embodiment of a vehicle hinge 1 in a side view. The vehicle hinge 1 comprises a first hinge half 2, the first hinge half 2 comprising a first hinge half part 3. The first hinge half part 3 is made of metal and has a first attaching portion 4 having an opening 5 for attaching the first hinge half part 3 to a vehicle flap F.

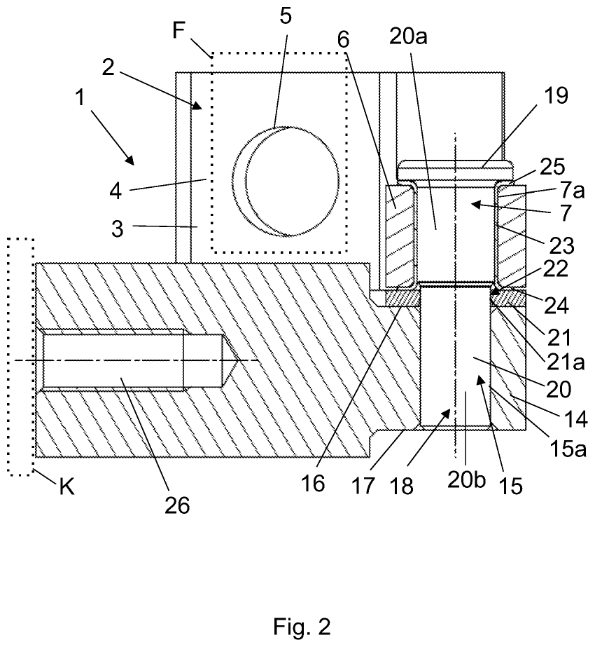

Adjoining the first attaching portion 4, the first hinge half part 3 has a first bearing portion 6 which comprises a first hinge eye 7 (shown in FIG. 2) having a vertical bearing axis L. The first hinge eye 7 has an upper face 8 and a lower face 9 which delimit the extent of the hinge eye 7 upward and downward along the bearing axis L.

The vehicle hinge 1 further comprises a second hinge half 10, the second hinge half 10 comprising a second hinge half part 11. The second hinge half part 11, like the first hinge half part 3, is made of metal and has a second attaching portion 12 having an opening 13 for attaching the second hinge half part 11 to a vehicle body K.

Adjoining the second attaching portion 12 of the second hinge half part 11, the second hinge half part 11 has a second bearing portion 14 which comprises a second hinge eye 15 (shown in FIG. 2) having the vertical bearing axis L. The second hinge eye 15, like the first hinge eye 7, has an upper face 16 and a lower face 17 which delimit the extent of the second hinge eye 15 upward and downward along the bearing axis L.

The first hinge half 2 and the second hinge half 10 are connected to one another in an articulated manner via a hinge pin 18 such that the first hinge half 2 and the second hinge half 10 can be rotated relative to one another about the vertical bearing axis L. In particular, this allows a pivoting movement of the vehicle flap F relative to the vehicle body since the first attaching portion 4, which is connected to the vehicle flap F, can be rotatably moved with respect to the second attaching portion 12, which is connected to the vehicle body K. The bearing axis L thus simultaneously forms the axis of rotation of the vehicle flap.

The hinge pin 18 has a head 19 on the end face and a shaft 20 which adjoins the head 19. The shaft 20 is stepped and has first an articulated portion 20a and a locking portion 20b (see FIG. 2) adjoining the head 19. On an outer face of the second hinge half part 11, there is a hole (not shown here) which has an internal thread and through which a locking means 60 designed as a set screw is guided such that the set screw 60 together with the locking portion 20b of the shaft 20 of the hinge pin 18 allows rotationally secure locking of the hinge pin 18 with respect to the second hinge half part 11 by means of screwing. The shaft 20 of the hinge pin 18 penetrates the first hinge eye 7 and the second hinge eye 15 such that the hinge pin connects the first hinge half part 3 and the second hinge half part 11 to one another in an articulated manner.

A retaining ring 21 is arranged between the first hinge half 2 or the first hinge half part 3 and the second hinge half 10 or the second hinge half part 11, which retaining ring, like the first hinge eye 7 and the second hinge eye 15, is penetrated by the shaft 20 of the hinge pin 18. The retaining ring 21 is arranged between the lower face 9 of the first hinge eye 7 and the upper face 16 of the second hinge eye 15.

The retaining ring 21 is designed as a perforated plate, wherein the outer diameter of the retaining ring 21 approximately corresponds to the outer diameter of the upper face 16 of the second hinge eye 15. The inner diameter of the retaining ring 21 in turn corresponds to the outer diameter of a retaining portion 22 which is provided on the shaft 20 of the hinge pin 18 between the articulated portion 20a and the locking portion 20b. The retaining ring 21 is correspondingly held axially by means of a press fit on the retaining portion 22 of the shaft 20.

FIG. 2 shows the embodiment of a vehicle hinge 1 shown in FIG. 1 in a side view cut away along the plane A-A shown in FIG. 1. As can be seen clearly in FIG. 2, a bearing bush 23, which has a first collar 24 and a second collar 25, is arranged in the first hinge eye 7 of the first bearing portion 6. As a result, the hinge pin 18 is mounted in an articulated manner within the first hinge eye 7. The first eye bore 7a of the first hinge eye 7 and the second eye bore 15a of the second hinge eye 15 have different diameters, the diameter of the first eye bore 7a being larger than the diameter of the second eye bore 15a.

In the view shown in FIG. 2, the exact arrangement of the retaining ring 21 between the first hinge half 2 and the second hinge half 10 can be seen particularly well. The retaining ring 21 has a hole 21a in its center, the diameter of the hole 21a corresponding to the outer diameter of the retaining portion 22 provided on the shaft 20. As a result, the retaining ring 21 is axially fixed to the retaining portion 22 of the hinge pin 18 by means of a press fit. As a result, the hinge pin 18 is axially secured from slipping out axially by the head 19 and the retaining ring 21 in the first hinge eye 7 or the first eye bore 7a.

The retaining ring 21 is arranged in the axial direction between the upper face 16 of the second hinge eye 15 and the first collar 24 of the bearing bush 23. This advantageously ensures that the retaining ring 21 does not adversely affect the pivotability of the first hinge half 2 with respect to the second hinge half 10. Rather, the retaining ring 21 substantially serves to ensure that the hinge pin 18 does not fall out of the first hinge half 2, for example during transport or assembly, and is designed to be more stable than a rivet head.

In the cut-away view shown in FIG. 2, it can be seen that the second hinge half part 11 has, in addition to the opening 13, a counterbore 26 which is also used to attach the second hinge half part 11 to the vehicle body K.

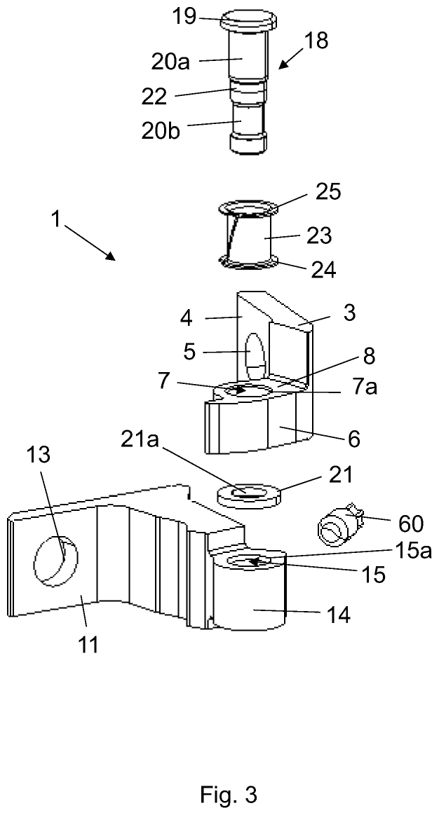

FIG. 3 shows the vehicle hinge shown in FIG. 1 or FIG. 2 in an exploded view. In this view, the structures of the built-in components can be seen better due to the separated perspective view.

The vehicle hinge 1 is composed of the first hinge half part 3 which comprises the attaching portion 4 having the opening 5, and a bearing portion 6 which adjoins said attaching portion at an angle.

The bearing portion 6 has a hinge eye 7 having an eye bore 7a in which the bearing bush 23 having a first collar 24 and a second collar 25 can be arranged. The bearing bush 23 is designed as a rolled bush made of metal. The upper face 8 of the hinge eye 7 can also be seen.

The vehicle hinge 1 further comprises the second hinge half part 11, the second hinge half part 11 comprising the second attaching portion 12 having the opening 13, and the second bearing portion 14 which adjoins said attaching portion at an angle. The second hinge eye 15 having the second eye bore 15a is arranged in the bearing portion 14.

The first hinge half part 3 and the second hinge half part 11 are connected to one another in an articulated manner via the hinge pin 18, the hinge pin 18 comprising a head 19 and a shaft 20 having an articulated portion 20a and a 20 locking portion 20b. A retaining portion 22, to which the retaining ring 21 having the hole 21 a is fixedly arranged by means of a press fit, is provided between the articulated portion 20a and the locking portion 20b.

The present disclosure was explained above using an embodiment in which a retaining ring 21 is arranged between the first hinge half 2 and the second hinge half 10. It is understood that more than one retaining ring can also be arranged between the first hinge half and the second hinge half in order to further increase the retaining force for securing the hinge pin in the eye bore.

The present disclosure has been explained above using an embodiment in which the hinge pin is stepped. It is understood that the hinge pin can also be designed without steps, in particular the hinge portion and the locking portion also being separated by the retaining portion or by the retaining ring arranged on the retaining portion.

What is claimed is:

1-10. (canceled)

11. A vehicle hinge comprising:
a first hinge half having at least one first hinge half part;
a second hinge half;
a hinge pin connecting the first hinge half and the second hinge half in an articulated manner, wherein the hinge pin is mounted in an articulated manner in one of the first hinge half and the second hinge half and said hinge pin is lockable on the other of the first hinge half and the second hinge half in a rotationally fixed manner; and
a retaining ring which is penetrated by a retaining portion of the hinge pin, the retaining ring being arranged between the first hinge half and the second hinge half, and wherein the retaining ring is fixed by a central hole to the retaining portion of the hinge pin by a press fit.

12. The vehicle hinge according to claim 11, wherein the hinge pin has a stepped shaft.

13. The vehicle hinge according to claim 11, wherein the hinge pin has a locking portion on which the hinge pin is lockable on the other of the first hinge half and the second hinge half in a rotationally fixed manner.

14. The vehicle hinge according to claim 11, wherein the hinge pin is locked on the other of the first hinge half and the second hinge half by a lock.

15. The vehicle hinge according to claim 14, wherein the lock is designed as a set screw.

16. The vehicle hinge according to claim 11, wherein the one of the first hinge half and the second hinge half together with the retaining ring are liftable out of the other of the first hinge half and the second hinge half.

17. The vehicle hinge according to claim 11, wherein the first hinge half comprises a first hinge eye which is penetrated by the hinge pin.

18. The vehicle hinge according to claim 17, wherein the first hinge eye defines a bearing axis through a first eye bore, the first hinge half being rotatable relative to the second hinge half about the bearing axis.

19. The vehicle hinge according to claim 18, wherein the second hinge half comprises a second hinge eye which is penetrated by the hinge pin.

20. The vehicle hinge according to claim 19, wherein the second hinge half comprises a second eye bore, wherein the first eye bore has a diameter which differs from a diameter of the second eye bore.

21. The vehicle hinge according to claim 19, further comprising a hollow cylindrical bearing bush, wherein the bearing bush penetrates the first hinge eye or the second hinge eye.

22. The vehicle hinge according to claim 21, wherein the bearing bush has at least one first collar, the first collar being arranged between the retaining ring and the one of the first hinge half and the second hinge half.

23. The vehicle hinge according to claim 22, wherein the bearing bush has a second collar, wherein the second collar is arranged between an upper face of the first hinge eye and an end-face head of the hinge pin.

24. A method for producing a hinge half of a vehicle hinge, the vehicle hinge comprising a hinge half part having a hinge eye, a hinge pin having an end-face head and a shaft, and a retaining ring, the method comprising the steps of:
inserting the shaft of the hinge pin into the hinge eye until the head of the hinge pin is arranged above an upper face of the hinge eye; and
pressing a retaining ring onto the retaining portion of the hinge pin during or after insertion of the shaft of the hinge pin into the hinge eye.
